(19) United States
(12) Patent Application Publication
(10) Pub. No.: US 2013/0046623 A1
(43) Pub. Date: Feb. 21, 2013

(54) Method For Providing a Recommendation, Recommender System, and Recommender Computer Program Product

(71) Applicants: Simon MORITZ, Solna (SE); Mattias Lidström, Stockholm (SE); Rickard Cöster, Hagersten (SE)

(72) Inventors: Simon MORITZ, Solna (SE); Mattias Lidström, Stockholm (SE); Rickard Cöster, Hagersten (SE)

(73) Assignee: Telefonaktiebolaget L M Ericsson (publ), Stockholm (SE)

(21) Appl. No.: 13/211,520

(22) Filed: Aug. 17, 2011

(51) Int. Cl. G06Q 30/02

(52) U.S. Cl. 705/14.53

(57) ABSTRACT

A recommender system that selects one or more items to recommend to a user of a communication device, wherein the recommender system uses one or more of the following profiles to select the one or more items: a device profile associated with the communication device; a location profile associated with the communication device, and a device type profile associated with a device type that matches the communication device's device type. The recommender system may also use a user profile associated with the user to select the one or more items.

### TECHNICAL FIELD

The disclosure herein relates to the field of recommender systems.

### BACKGROUND

Recommender systems are a common component of an e-commerce system. A recommender system functions to select items, such as, for example, consumer products (e.g., books, computers, or other consumer goods), entertainment content (e.g., music, movies, TV programs), news stories, web pages, publications, services, and applications, to recommend to a user. Recommender systems may use filtering techniques that attempt to enable the recommender system to select items that are likely to be of interest to the user. Typically, a recommender system that provides personalized recommendations compares a user's profile to some reference characteristics, and seeks to predict a rating that the user would give to an item the user has not yet rated (implicitly or explicitly). These characteristics may be from the information item (the content-based approach) or the user's social environment (the collaborative filtering approach).

While recommender systems that function to provide personalized recommendations are prevalent today, there is, nonetheless, a desire for improving such recommender systems.

### SUMMARY

In a typical e-commerce system having a recommender system, the recommender system provides to a user a recommendation identifying items that may be of interest to the user. For example, when a user goes to an e-commerce site (e.g., Amazon.com) that maintains a “consumption” history for the user (e.g., information identifying the items the user previously consumed through the site, such as information identifying items the user previously purchased, downloaded, viewed, listened to, played, previewed, clicked on, read, interacted with, etc.), the recommender system for the site may select items to recommend to the user based on the user's consumption history. That is, for example, the recommender system may recommend to the user items that are similar to an item the user previously consumed (e.g., viewed). It is also typical for the recommender system to provide to the user a recommendation identifying items that other users who are “similar” to the user have rated favorably (either implicitly or explicitly). A classic example is Amazon's “customers who bought or viewed book X also bought or viewed book Y” feature.

While it may be advantageous to provide to a user using a particular communication device a recommendation for items similar to some item the user consumed in the past, it may also be advantageous, in some embodiments, to provide to the user a recommendation for items similar to some item the user or some other user consumed in the past using the same communication device or the same type of communication device. For example, if the user is currently using a particular desktop computer, then it may be advantageous to provide to the user a recommendation based on an item that was previously consumed using that particular desktop computer, regardless of whether it was the user or some other user who consumed the item using the particular desktop computer. As another example, if the user has two laptop computers in his home and is currently using one of the laptop computers, then it may be advantageous to provide to the user a recommendation based on an item that was previously consumed using the other laptop computer, regardless of whether it was the user or some other user who consumed the item using the other laptop computer.

Also, it may also be advantageous, in some embodiments, to provide to a user using a particular communication device a recommendation for items similar to some item the user (or another user) consumed in the past using a different communication device that has a relationship with the particular communication device. For example, the relationship may be that both the particular communication device and the other communication device are both used and located in the same location (e.g., the same home or office). In such embodiments, it may further be advantageous when selecting items to recommend to a user to take into account the communication device the user is currently using. For example, if the user is currently using a communication device having a relatively small display screen (e.g., a smartphone), then, in some embodiments, it is advantageous to take this into account so that, for example, the recommender system does not recommend to the user an item that is not designed to be consumed using a communication device that has a small display screen.

Accordingly, in some embodiments, a recommendation engine of a recommender system provides a communication device user with a recommendation based on, at least in part, a location profile, a device profile, and/or a device type profile.

In one aspect, a method for recommending a set of one or more items to a user of a first communication device is provided. In some embodiments the method includes obtaining, by a recommender system, a complete location profile associated with the first communication device. The complete location profile may include a set of item identifiers, wherein (i) each item identifier included in the set of item identifiers identifies an item that had been consumed using a communication device associated with the complete location profile, (ii) the first communication device and a second communication device that is separate and distinct from the first communication device are both associated with the complete location profile, and (iii) the set of item identifiers includes at least one item identifier that identifies an item that has not been consumed using the first communication device.

In this embodiment, the method also includes obtaining, by the recommender system, a first device profile associated with the first communication device. The first device profile may include static information pertaining to the first communication device and/or dynamic information identifying a set of items consumed using the first communication device.

In this embodiment, the method further includes determining the set of one or more items to recommend to the user; and transmitting, from the recommender system to the first communication device, information identifying the determined set of one or more items. In some embodiments, the step of determining the set of one or more items to recommend to the user comprises using (a) information from the complete location profile and (b) information from the first device profile to select one or more items to include in the set of one or more items to recommend to the user.

In some embodiments, the step of determining the set of items to recommend to the user using said information obtained from the complete location profile and said information obtained from the first device profile comprises: determining a set of candidate items using said information obtained from the complete location profile; and filtering the set of candidate items using static information obtained from the first device profile.

In some embodiments, the method also includes storing a device type profile associated with a communication device type identifier associated with a particular communication device type, wherein the first communication device is of said particular communication device type, and the device type profile comprises, for each of a plurality of users, each of whom is a different user than the first user, information identifying items consumed by the user using a communication device, other than the first communication device, of said particular communication device type. In this embodiment, the method may further include receiving a message from the first communication device prior to performing the step of determining the set of one or more items to recommend to the user. The message may include the communication device type identifier or an identifier associated therewith. The step of determining the set of recommended items may further include: using the communication device type identifier or the identifier associated therewith to obtain from the device type profile information that identifies an item consumed by one of said plurality of users using a communication device of said particular communication device type other than the first communication device; and determining the set of items to recommend to the user using said information obtained from the complete location profile, said information obtained from the device type profile, and said information obtained from the first device profile.

In some embodiments, the method further includes: storing a user profile associated with a user identifier chosen by the user, wherein the user profile comprises information identifying a set of items consumed by the user; and receiving a message from the first communication device prior to performing the step of determining the set of one or more items to recommend to the user. In some embodiments, the message includes the user identifier or an identifier associated therewith; and the step of determining the set of recommended items further comprises: using the user identifier or the identifier associated therewith to obtain from the user profile information that identifies an item consumed by the user; and determining the set of items to recommend to the user using said information obtained from the complete location profile, said information obtained from the user profile, and said information obtained from the first device profile.

In some embodiments, the method may further include providing a recommender application to be installed on the first communication device, wherein, in response the user using the first communication device to consumer an item, the recommender application transmits to a recommender system a message comprising an identifier identifying the consumed item and an identifier associated with the first communication device; and adding the identifier identifying the consumed item to the complete location profile.

In another aspect, a recommender system for recommending a set of items to a user of a first communication device is provided. In some embodiments, the recommender system includes a network interface for receiving and transmitting message; and a data processing system. The data processing system being operable to: (A) obtain a complete location profile associated with the first communication device; (B) obtain a first device profile associated with the first communication device; (C) determine the set of one or more items to recommend to the user; and (D) use the network interface to transmit to the first communication device information identifying the determined set of one or more items. In some embodiments, the data processing system is configured to determine the set of one or more items to recommend to the user by using (a) information from the complete location profile and (b) information from the first device profile to select one or more items to include in the set of one or more items to recommend to the user.

In some embodiments, the complete location profile includes a set of item identifiers, where (i) each item identifier included in the set of item identifiers identifies an item that had been consumed using a communication device associated with the complete location profile, (ii) the first communication device and a second communication device that is separate and distinct from the first communication device are both associated with the complete location profile, and (iii) the set of item identifiers includes at least one item identifier that identifies an item that has not been consumed using the first communication device. In some embodiments, the first device profile includes static information pertaining to the first communication device and/or dynamic information identifying a set of items consumed using the first communication device

In still another aspect, a recommender computer program product comprising a non-transitory computer-readable medium comprising instructions for execution by a processor of a recommender system is provided. In some embodiments, the instructions include instructions for obtaining a complete location profile associated with a first communication device, the complete location profile comprising a set of item identifiers, wherein (i) each item identifier included in the set of item identifiers identifies an item that had been consumed using a communication device associated with the complete location profile, (ii) the first communication device and a second communication device that is separate and distinct from the first communication device are both associated with the complete location profile, and (iii) the set of item identifiers includes at least one item identifier that identifies an item that has not been consumed using the first communication device.

In some embodiments, the instructions also include instructions for obtaining a first device profile associated with the first communication device, the first device profile comprising static information pertaining to the first communication device and/or dynamic information identifying a set of items consumed using the first communication device.

In some embodiments, the instructions further include instructions for determining the set of one or more items to recommend to a user of the first communication device and instructions for transmitting, from the recommender system to the first communication device, information identifying the determined set of one or more items.

In some embodiments, the instructions for determining the set of one or more items to recommend to the user comprises instructions for using (a) information from the complete location profile and (b) information from the first device profile to select one or more items to include in the set of one or more items to recommend to the user.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments and, together with the description, further serve to enable a person skilled in the pertinent art to make and use, for example, a recommender system disclosed herein as well as a method for recommendation, a recommender computer program and a recommender computer program product (e.g., a computer-readable medium) that comprises the recommender computer program.

FIG. 1 illustrates an exemplary recommender system.

FIG. 2 further illustrates various components of the example recommender system.

FIG. 3 is a flow chart illustrating a processes according to an embodiment.

FIG. 4 is a diagram illustrating how consumption information may be combined.

FIG. 5 is a diagram illustrating how consumption information from a device type profile or location profile may be combined with consumption information from a device profile or user profile.

FIG. 6 is a diagram showing inputs to a recommender engine and outputs from the recommender engine.

FIG. 7 is a block diagram of a particular embodiment of a recommender system or components thereof.

FIG. 8 is a block diagram illustrating example software components of a recommender system according to some embodiments.

### DETAILED DESCRIPTION

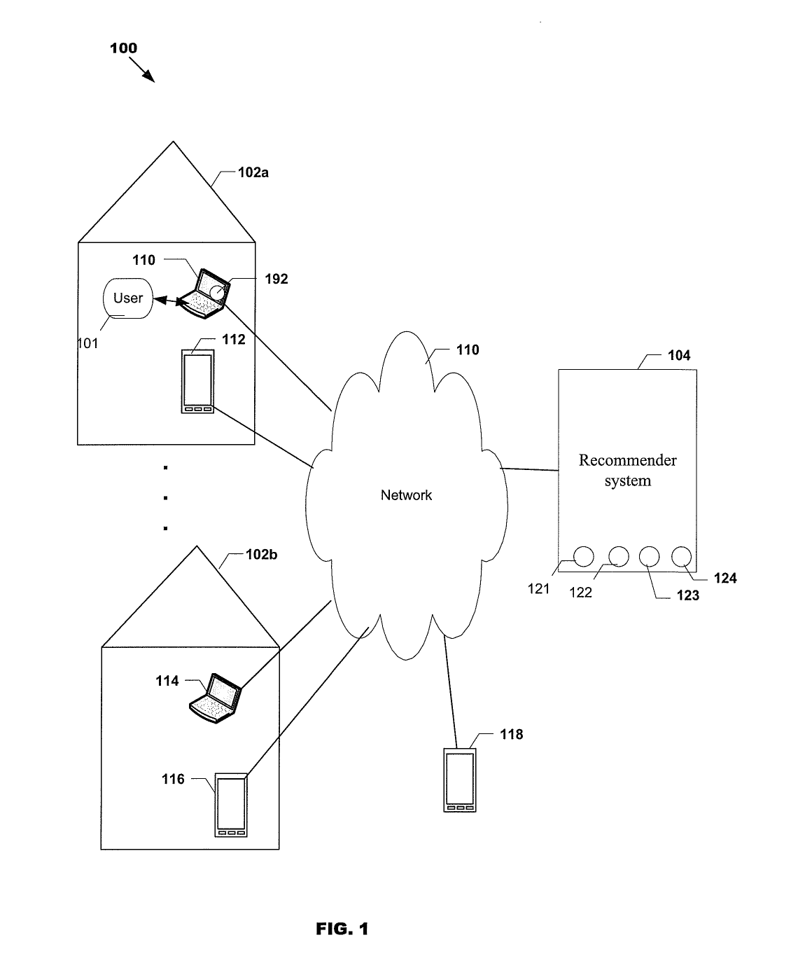

FIG. 1 illustrates an example system 100, according to some embodiments. In the example shown, system 100 includes a number of locations 102 (locations 102a and 102b are shown). A location 102 may be a home, office, college campus, or the like. As indicated, a number of communication devices may be associated with each location 102. In the example shown, communication devices 110 and 112 are associated with location 102a and communication devices 114 and 116 are associated with location 102b. There may also exist communication devices (e.g., communication device 118) that are not associated with any location. A communication device associated with one location may be of the same type as another device (e.g., another device associated with a different location or another device not associated with any location). For example, communication devices 110 and 114 are of the same type (e.g., both laptop computers), and communication devices 112, 116, and 118 are of the same type (e.g., all are smartphones). In some embodiments, a communication device can be a set-top-box or a remote control device for controlling a set-top-box and/or a television.

System 100 may include a network 110 that enables each communication device 110, 112, 114, 116 and 118 to communicate with a recommender system 104. Although FIG. 1 shows recommender system 104 being external to locations 102a,b, in some embodiments, recommender system 104 (or some components thereof) may be located at the location 102a and/or 102b.

Regardless of where components of recommender system 104 may be located, recommender system 104 functions to provide recommendations to users (e.g., user 101). In the example shown, user 101 is presently located within location 102a and is currently using communication device 110. Accordingly, in such a scenario, recommender system 104, in some embodiments, may select a set of one or more items to recommend to user 101 based on one or any combination of the following: (1) a user profile 121 associated uniquely with user 101, (2) a device profile 122 associated uniquely with communication device 110, (3) a location profile 123 associated uniquely with location 102a, and (4) a device type profile associated uniquely with a particular device type that matches communication device 110's device type.

In some embodiments, user profile 121 may include demographic information pertaining to user 101 (e.g., age, sex, etc), preference information for user 101, and consumption information pertaining to user 101 (e.g., information identifying a set of items consumed by user 101); device profile 122 may include static device information pertaining to device 110 (e.g., information identifying device 110's device type, information identifying attributes of the device) and consumption information pertaining to device 110 (e.g., information identifying a set of items consumed using device 110); location profile 123 may include location information and consumption information; and device type profile 124 may include device type information and consumption information.

In some embodiments, the location information of location profile 123 may include information identifying characteristics of location 102a (e.g., information identifying whether location 102a is a home, office, campus; information identifying what type of network (e.g., Internet) connection exists at location 102a) and information identifying the particular communication devices that are associated with location 102a. In some embodiments, the consumption information of location profile 123 may include information that identifies a set of items, were each item included in the set was consumed using a device associated with location 102a.

In some embodiments, the device type information of device type profile 124 includes information identifying characteristics of the particular device type that matches communication device 110's device type; and the consumption information of device type profile 124 includes information identifying a set of items, where each item included in the set was consumed using a device having a type that matches communication device 110's device type.

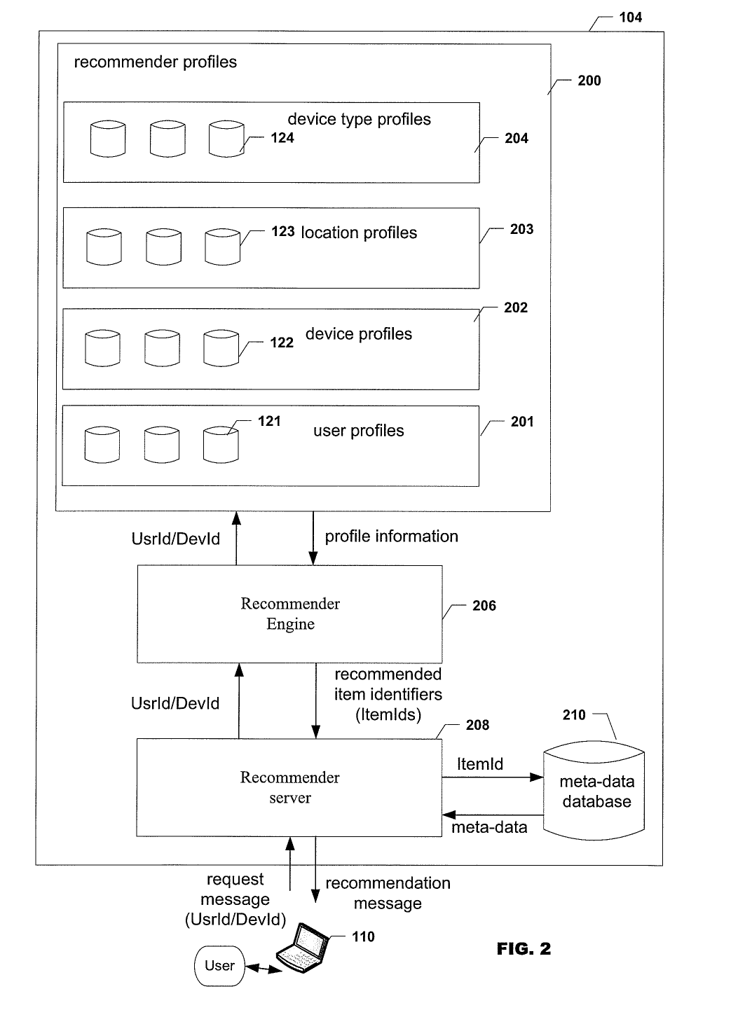

FIG. 2 illustrates a functional block diagram of recommender system 104 according to some embodiments. In the example shown, recommender system 104 includes a set of recommender profiles 200, which includes: a set of user profiles 201, a set of device profiles 202, a set of location profiles 203, and a set of device type profiles 204. As also shown, recommender system 104 may include a recommender server 208 (e.g., a web server) for receiving requests from clients (e.g., communication device 110) and for transmitting responses back to the requesting clients.

Recommender system 104 may also include a recommender engine 206 that functions to obtain (e.g., retrieve and/or generate) one or more profiles from the set of recommender profiles 200 and to use information obtained from the one or more obtained profiles to select a set of items to recommend to a user in response to recommender server 208 receiving a request. Recommender engine 206, after selecting a set of items to recommend to a user, may provide to recommender sever 208 a list of item identifiers, where each item identifier included in the list identifies one of the selected recommended items. Recommender server 208 may use the list of item identifiers to obtain from a meta-data database 210, for one or more of the identified items, meta-data associated with the identified item. Recommender server 208 may then transmit, in response to the request, the list of item identifiers and the obtained meta-data.

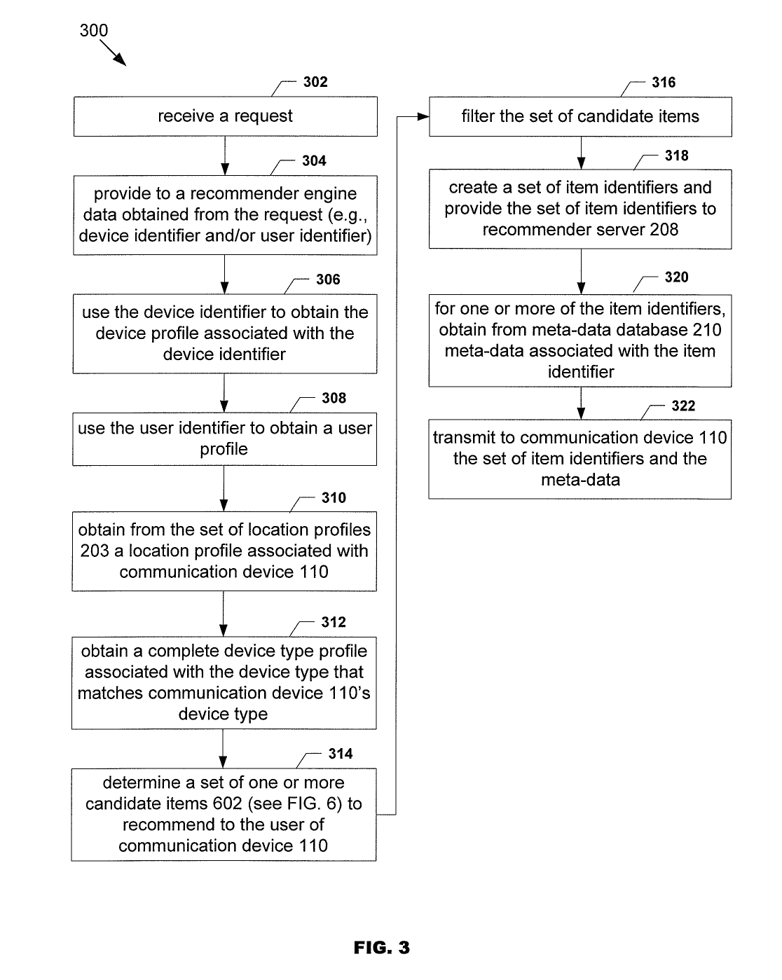

FIG. 3 is a flow chart illustrating a process 300, according to some embodiments, that may be performed by recommender system 104 in response to recommender system 104 receiving a request for a recommendation. In this example, we shall assume the request was transmitted from communication device 110, but the request could have been transmitted by any device or server.

Process 300 may begin in step 302, where recommender server 208 receives the request. The request may include a device identifier associated with communication device 110. For example, if communication device 110 is a mobile phone, the device identifier could be the International Mobile Equipment Identity (IMEI) of the phone or some other identifier uniquely associated with the mobile phone. The request may also include a user identifier associated with the current user of device 110 (user 101).

In step 304, recommender server 208 provides data obtained from the request (e.g., the device identifier and user identifier, if any) to recommender engine 206.

In step 306, recommender engine 206 uses the device identifier to obtain (e.g., retrieve) the device profile associated with the device identifier (in this example, device profile 122). For example, in step 306, recommender engine 206 may search each device profile included in the set of device profiles 202 for the device profile that includes a device identifier that matches the received device identifier, or recommender engine 206 may search a device profile table for a key field of a record that matches the received device identifier, where the matching record contains a pointer to device profile 122. In this example, since device profile 123 is associated with communication device 110, recommender engine 206 will obtain device profile 123.

In step 308, recommender engine 206 uses the user identifier to obtain the user profile (e.g., user profile 121) associated with the received user identifier.

In step 310, recommender engine obtains from the set of location profiles 203 a location profile associated with communication device 110 (e.g., a location profile associated with the device identifier associated with communication device 110). In some embodiments, recommender engine 206 is able to determine the location profile that is associated with communication device 110 because the device profile 123 includes a pointer to the location profile. In other embodiments, recommender engine 206 is able to determine the location profile that is associated with communication device 110 by searching each location profile within the set of location profiles 203 until a location profile is found that includes a device identifier that matches the received device identifier, or searching a location profile table that maps device identifiers to a location profile. In this example, in step 310, recommender engine obtains location profile 123.

In some embodiments, the location profile obtained in step 310 is a complete location profile (i.e., the location profile contains consumption information that identifies a set of one or more items, were each item included in the set was consumed using a device associated with the location profile). In other embodiments, the location profile obtained in step 310 is an incomplete location profile. In such embodiments, after obtaining the location profile in step 310, recommender engine obtains (e.g., generates or builds) a complete location profile based on the incomplete location profile. For example, in some embodiments, the incomplete location profile identifies, for each communication device associated with the location profile, the device profile 202 associated with the communication device. Recommender engine 206 then uses the consumption information from each of the identified device profiles 202 to generate the consumption information for the location profile, thereby generating the complete location profile.

In step 312, recommender engine obtains a complete device type profile associated with the device type that matches communication device 110's device type (e.g., device type profile 124). A complete device type profile is a device type profile that includes the appropriate consumption information (e.g., a set of item identifiers, where each item included in the set identifies an item that was consumed using a device that matches communication device 110's device type but is separate and distinct from communication device 110). In some embodiments, recommender engine 306 is able to determine communication device 110's device type because device profile 123 may include information that identifies communication device 110's device type.

In some embodiments, recommender engine 206 obtains the complete device type profile simply by retrieving it from the set of device type profiles 204. That is, in some embodiments, complete device type profiles are generated before recommender sever 208 receives the request.

In other embodiments, recommender engine 206 obtains the complete device type profile by building it on-the-fly (e.g., it is built in response to recommender engine 206 receiving the request from recommender server 208). That is, for example: (i) recommender engine 206 locates each and every device profile 202 that is associated with a device having a device type that matches communication device 110's device type, (ii) for each such device profile, recommender engine 206 obtains the consumption information from the device profile, and (iii) recommender engine 206 then combines the consumption information from the device profiles 202 to produce the consumption information for the device type profile.

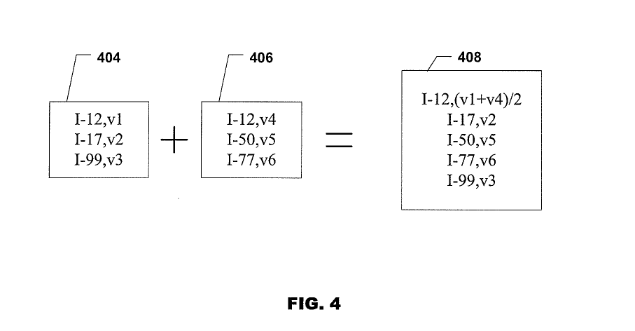

FIG. 4 illustrates how consumption information 404 from a first device profile can be combined with consumption information 406 from a second device profile to generate consumption information 408 for a location profile or a device type profile. FIG. 4 also shows that, in addition to including a set of item identifiers, consumption information from a device profile may also include a value associated with each item identifier. A value associated with an item identifier may represent an implicit or explicit user rating for the item identified by the item identifier. As shown in FIG. 4, if two device profiles have the same item identifier, then the values may be averaged when building the consumption information for the location/device type profile.

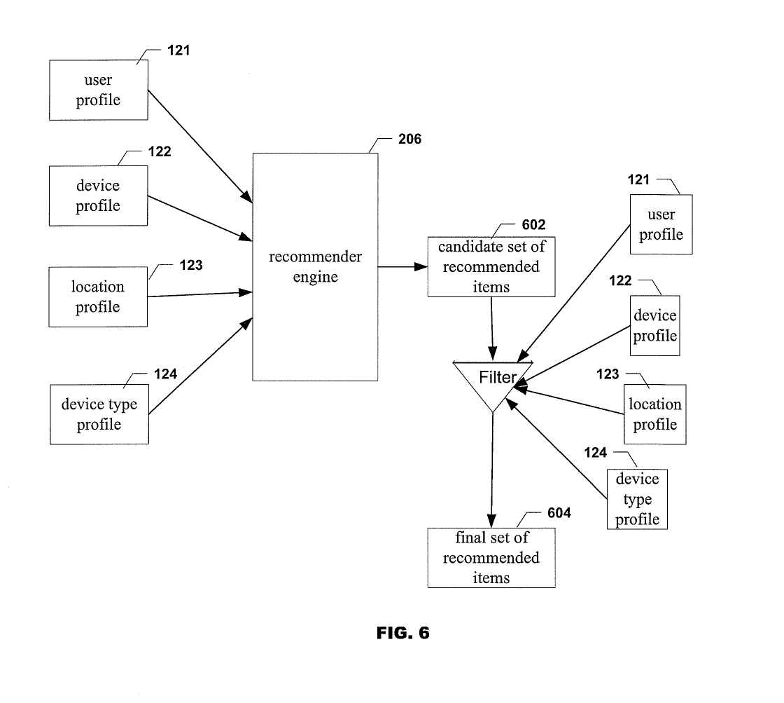

In step 314, recommender engine 206 determines a set of one or more candidate items 602 (see FIG. 6) to recommend to the user of communication device 110. For example, in step 314 recommender engine may use one or more of: (i) consumption information from the location profile 123, (ii) consumption information from device type profile 124, (iii) information from the device profile 122, and (iv) information from user profile 121, to select one or more items to include in the set of one or more candidate items 602 to recommend.

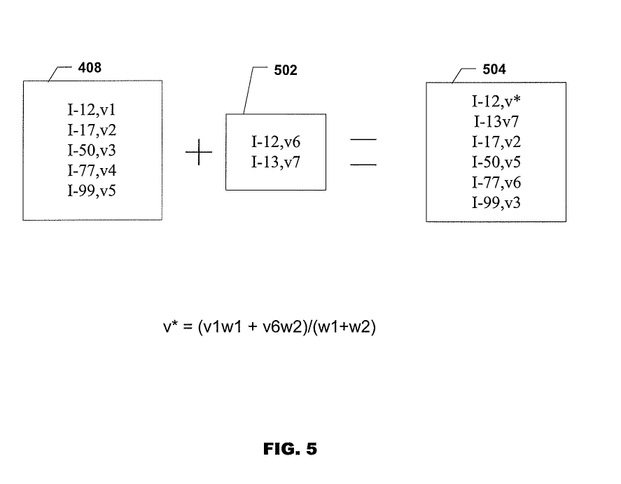

For example, in some cases, prior to selecting the set of candidate items 602 to recommend to user 101, recommender engine 206 may use weights to combine one or more the above mentioned profiles. This is illustrated in FIG. 5, which shows consumption information 408 for a location profile (or a device type profile) being combined with consumption information 502 from device profile 122 (or user profile 121) to produce combined consumption information 504, and also shows that a weight w1 is assigned to consumption information 408 and a weight w2 is assigned to consumption information 502. In some embodiments, w2>w1 since, presumably, consumption information 502 better represents user 101's preferences. After producing combined consumption information 504, recommender engine 206 may use combined consumption information 504 to select one or more items to add to the set of candidate items 602 to recommend to user 101. Ways in which recommender engine 206 may use combined consumption information 504 to select one or more items to add to the set of candidate items 602 are well known in the art (e.g., collaborative filtering).

In some embodiments, recommender engine 206 may have a set of rules to follow in deciding which of the profiles 122-124 to use to produce the candidate set of items 602 in step 314. For example, if user 101 is currently using communicate device 110 (i.e., a smartphone) but has not entered his user identifier, then a rule may indicate that the most suitable profile to use is the device profile associated with communication device 110 (i.e., device profile 122). On the other hand, if user 101 is currently using communicate device 110 but has entered his user identifier, then a rule may indicate that the most suitable profiles to use are the user profile associated with the user's user identifier (i.e., user profile 121) and device profile 122. As another example, if user 101 is currently using communicate device 110 and communicate device 110 recommender system 104 has no consumption information for communication device 110, then a rule may indicate that the most suitable profiles to use are the location profile 123 and/or the device type profile 124.

In step 316, recommender engine 206 may filter the set of candidate items 602 (e.g., remove items from the candidate set 602) to produce a final set of items 604 to recommend to user 101. Recommender engine 206 may filter the set of candidate items 602 using information from user profile 121 (e.g., demographic and/or preference information from user profile 121), device profile 122 (e.g., static device information from device profile 122), location profile 123 (e.g., static information from location profile 123), and/or device type profile 124 (e.g., device type information from profile 124).

For example, if one of the items in the candidate set 602 is an item that is on a “do not like” list found in user profile 121, then recommender engine may remove that item from the candidate set 602. As another example, if one of the items in the candidate set 602 is an item that is only suitable to be consumed on a device having a large screen, then recommender engine 206 may remove that item from the set if information from device profile 122 and/or device type profile 124 indicates that communication device 110 has a small display screen. As another example, if one of the items in the candidate set 602 is an item that is only suitable to be obtained via a broadband internet connection, then recommender engine 206 may remove that item from the candidate set 602 if information from location profile 122 and/or device type profile 124 indicates that communication device 110 does not have broadband network connection capabilities. Steps 314 and 316 are illustrated pictorially in FIG. 6.

In step 318, recommender engine 206 creates a set of item identifiers and provides the set of item identifiers to recommender server 208, where each item identifier included in the set of item identifiers identifies one of the items from the final set items 604.

In step 320, recommender server 208 may, for one or more of the item identifiers, obtain from meta-data database 210 meta-data associated with the item identifier.

In step 322, recommender server 208 transmits to communication device 110 the set of item identifiers and the meta-data, if any, obtained ins step 318.

In the above manner, intelligent recommendations may be provided to user 101 even if recommender system has no information about the items user 101 has consumed and/or has no information about any of the items consumed using communication device 110. Thus, recommender system 104, according to at least some embodiments, decreases the “cold start” problem that occurs when a new device is added to a location and/or a new user wants to receive a recommendation. Also, in some embodiments, a user can use a communication device anonymously (e.g., without logging in) and still receive relevant recommendations based on the device profile, device type profile and/or location profile associated with the communication device that the user is currently using to consume items. This feature makes things easier for the user as the user can be in a more “lean back” mode (which normally is preferred when sitting in front of the TV) instead of a “lean forward” mode (which is normal using a computer and most other recommender systems). Other advantages also exist.

Referring back to FIG. 1, a recommender application 192 may be provided to user 101 and installed on communication device 110. Recommender application 192 may be configured such that, in response to user 101 using device 110 to consume an item, the recommender application 192 may transmit to recommender system 104 (e.g., to recommender server 208) a message comprising an identifier identifying the consumed item and an identifier for identifying location profile 123. Recommender application 192 may be configured to transmit the message in immediate response to user 101 using device 110 to consume an item or at a later time. In response to receiving the message, recommend system 104 may add the identifier identifying the consumed item to the location profile 123. In this manner, location profiles can be kept up-to-date.

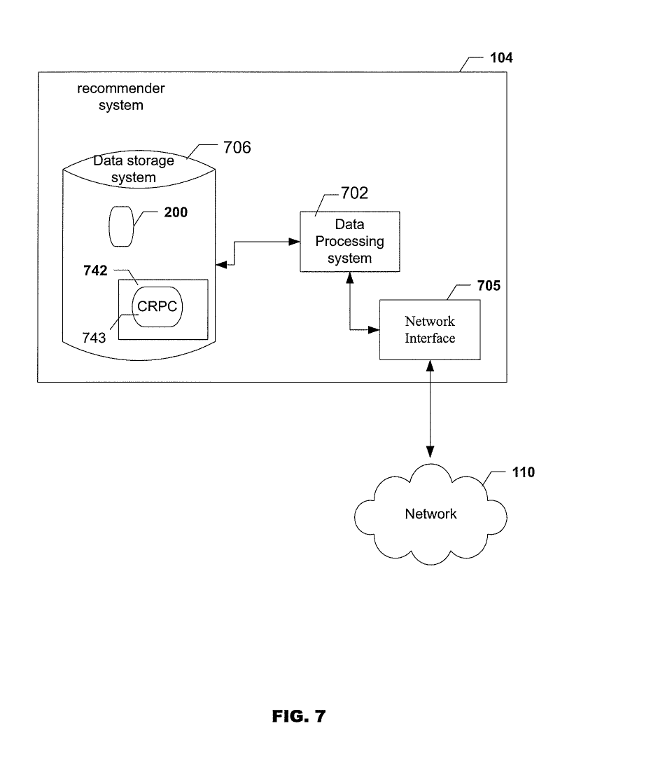

FIG. 7 illustrates a possible implementation for at least some components of recommender system 104 according to some embodiments of recommender system 104. As shown in FIG. 7, recommender system 104 may include: a data processing system 702, which may include one or more servers each having one or more microprocessors and/or one or more circuits, such as an application specific integrated circuit (ASIC), Field-programmable gate arrays (FPGAs), etc; a network interface 705 for receiving messages (e.g., messages transmitted from communication device 110); data storage system 706, which may include one or more computer-readable mediums, such as non-volatile storage devices and/or volatile storage devices (e.g., random access memory (RAM)). As shown, data storage system 706 may be used to store recommender profiles 200. In embodiments where data processing system 702 includes a microprocessor, a recommender computer program product is provided, which computer program product includes: computer readable program code 743, which implements a computer program, stored on a computer readable medium 742, such as, but not limited, to magnetic media (e.g., a hard disk), optical media (e.g., a DVD), memory devices (e.g., random access memory), etc. In some embodiments, computer readable program code 743 is configured such that when executed by a processor, code 743 causes the processor to perform steps described above (e.g., steps describe above with reference to the flow charts shown in FIG. 3).

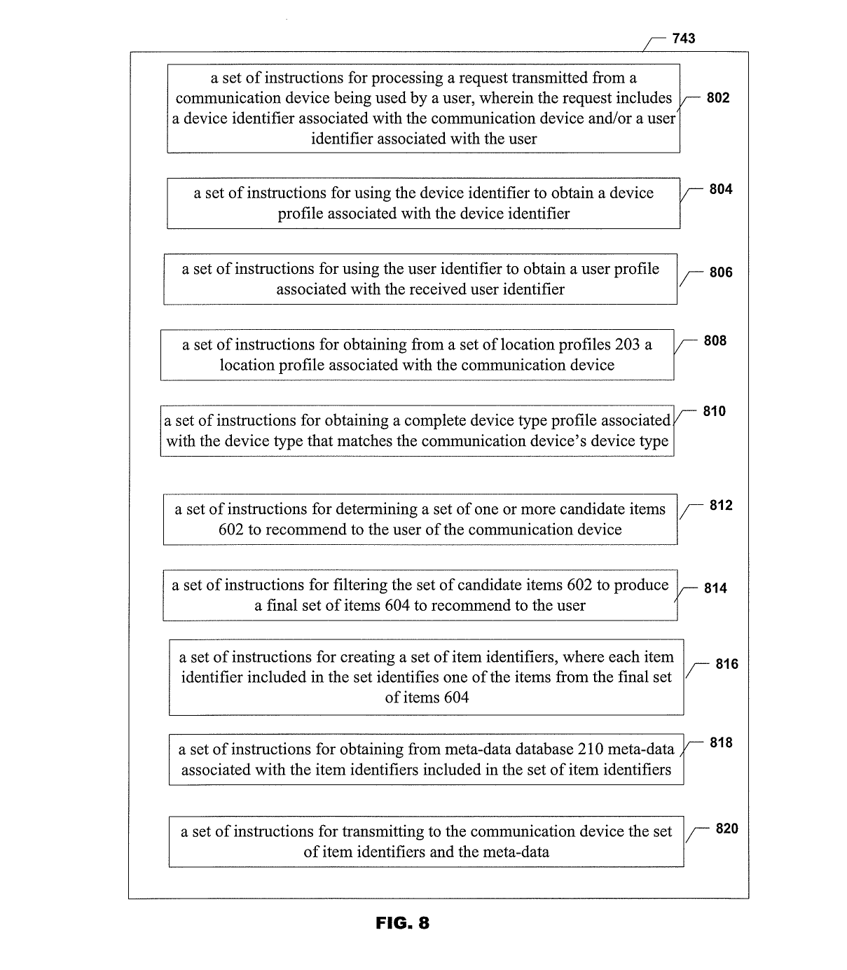

FIG. 8 illustrates an embodiment of computer readable program code (CRPC) 743. In the embodiment shown, CRPC 743 includes: (1) a set of instructions 802 for processing a request transmitted from a communication device being used by a user, wherein the request includes a device identifier associated with the communication device and/or a user identifier associated with the user, (2) a set of instructions 804 for using the device identifier to obtain a device profile associated with the device identifier, (3) a set of instructions 806 for using the user identifier to obtain a user profile associated with the received user identifier, (4) a set of instructions 808 for obtaining from a set of location profiles 203 a location profile associated with the communication device, (5) a set of instructions 810 for obtaining a complete device type profile associated with the device type that matches the communication device's device type, (6) a set of instructions 812 for determining a set of one or more candidate items 602 to recommend to the user of the communication device, (7) a set of instructions 814 for filtering the set of candidate items 602 to produce a final set of items 604 to recommend to the user, (8) a set of instructions 816 for creating set of item identifiers, where each item identifier included in the set identifies one of the items from the final set of items 604, (9) a set of instructions 818 for obtaining from meta-data database 210 meta-data associated with the item identifiers included in the set of item identifiers, and (10) a set of instructions 820 for transmitting to the communication device the set of item identifiers and the meta-data.

While various embodiments of the present invention have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for recommending a set of one or more items to a user of a first communication device, the method comprising:
obtaining, by a recommender system, a complete location profile associated with the first communication device, the complete location profile comprising a set of item identifiers, wherein (i) each item identifier included in the set of item identifiers identifies an item that had been consumed using a communication device associated with the complete location profile, (ii) the first communication device and a second communication device that is separate and distinct from the first communication device are both associated with the complete location profile, and (iii) the set of item identifiers includes at least one item identifier that identifies an item that has not been consumed using the first communication device;
obtaining, by the recommender system, a first device profile associated with the first communication device, the first device profile comprising static information pertaining to the first communication device and/or dynamic information identifying a set of items consumed using the first communication device;
determining the set of one or more items to recommend to the user; and
transmitting, from the recommender system to the first communication device, information identifying the determined set of one or more items, wherein
the step of determining the set of one or more items to recommend to the user comprises using (a) information from the complete location profile and (b) information from the first device profile to select one or more items to include in the set of one or more items to recommend to the user.

2. The method of claim 1, wherein the step of determining the set of items to recommend to the user using said information obtained from the complete location profile and said information obtained from the first device profile comprises:
determining a set of candidate items using said information obtained from the complete location profile; and filtering the set of candidate items using static information obtained from the first device profile.

3. The method of claim 1, further comprising storing a device type profile associated with a communication device type identifier associated with a particular communication device type, wherein
the first communication device is of said particular communication device type, and
the device type profile comprises, for each of a plurality of users, each of whom is a different user than the first user, information identifying items consumed by the user using a communication device, other than the first communication device, of said particular communication device type.

4. The method of claim 3, further comprising
receiving a message from the first communication device prior to performing the step of determining the set of one or more items to recommend to the user, wherein
the message includes the communication device type identifier or an identifier associated therewith; and
the step of determining the set of recommended items further comprises:
using the communication device type identifier or the identifier associated therewith to obtain from the device type profile information that identifies an item consumed by one of said plurality of users using a communication device of said particular communication device type other than the first communication device; and
determining the set of items to recommend to the user using said information obtained from the complete location profile, said information obtained from the device type profile, and said information obtained from the first device profile.

5. The method of claim 1, further comprising:
storing a user profile associated with a user identifier chosen by the user, wherein the user profile comprises information identifying a set of items consumed by the user; and
receiving a message from the first communication device prior to performing the step of determining the set of one or more items to recommend to the user, wherein
the message includes the user identifier or an identifier associated therewith; and
the step of determining the set of recommended items further comprises:
using the user identifier or the identifier associated therewith to obtain from the user profile information that identifies an item consumed by the user; and
determining the set of items to recommend to the user using said information obtained from the complete location profile, said information obtained from the user profile, and said information obtained from the first device profile.

6. The method of claim 1, further comprising
providing a recommender application to be installed on the first communication device, wherein, in response the user using the first communication device to consume an item, the recommender application transmits to a recommender system a message comprising an identifier identifying the consumed item and an identifier associated with the first communication device; and
adding the identifier identifying the consumed item to the complete location profile.

7. A recommender system for recommending a set of items to a user of a first communication device, comprising:
a network interface for receiving and transmitting message; and
a data processing system operable to:
obtain a complete location profile associated with the first communication device, the complete location profile comprising a set of item identifiers, wherein (i) each item identifier included in the set of item identifiers identifies an item that had been consumed using a communication device associated with the complete location profile, (ii) the first communication device and a second communication device that is separate and distinct from the first communication device are both associated with the complete location profile, and (iii) the set of item identifiers includes at least one item identifier that identifies an item that has not been consumed using the first communication device;
obtain a first device profile associated with the first communication device, the first device profile comprising static information pertaining to the first communication device and/or dynamic information identifying a set of items consumed using the first communication device;
determine the set of one or more items to recommend to the user; and
use the network interface to transmit to the first communication device information identifying the determined set of one or more items, wherein
the data processing system is configured to determine the set of one or more items to recommend to the user by using (a) information from the complete location profile and (b) information from the first device profile to select one or more items to include in the set of one or more items to recommend to the user.

8. The recommender system of claim 7, wherein the data processing system is configured to determine the set of items to recommend to the user using said information obtained from the complete location profile and said information obtained from the first device profile by:
determining a set of candidate items using said information obtained from the complete location profile; and
filtering the set of candidate items using static information obtained from the first device profile.

9. The recommender system of claim 7, further comprising a data storage system for storing a device type profile associated with a communication device type identifier associated with a particular communication device type, wherein
the first communication device is of said particular communication device type, and
the device type profile comprises, for each of a plurality of users, each of whom is a different user than the first and second user, information identifying items consumed by the user using a communication device, other than the first communication device, of said particular communication device type.

10. The recommender system of claim 9, wherein the data processing system is configured to determine the set of recommended items by:
obtaining from the device type profile information that identifies an item consumed by one of said plurality of users using a communication device of said particular communication device type other than the first communication device; and
using said information obtained from the complete location profile, said information obtained from the device type profile, and said information obtained from the first device profile to select one or more items to include in the set of one or more items to recommend to the user.

11. The recommender system of claim 7, further comprising a data storage system for storing a user profile associated with a user identifier chosen by the user, wherein the user profile comprises information identifying a set of items consumed by the user, wherein
the data processing system is configured to determine the set of recommended items by:
obtaining from the user profile information that identifies an item consumed by the user; and
using said information obtained from the complete location profile, said information obtained from the user profile, and said information obtained from the first device profile to select one or more items to include in the set of one or more items to recommend to the user.

12. The recommender system of claim 7, further comprising a recommender application installed on the first communication device, wherein, the recommender application is configured such that, in response the user using the first communication device to consumer an item, the recommender application transmits to a recommender server a message comprising an identifier identifying the consumed item and an identifier associated with the first communication device.

13. The recommender system of claim 7, wherein the first communication device is a mobile terminal and the second communication device is a set-top-box or a remote control communication device for controlling a set-top-box and/or a television.

14. A recommender computer program product comprising a non-transitory computer-readable medium comprising instructions for execution by a processor of a recommender system, the instructions comprising:
instructions for obtaining a complete location profile associated with a first communication device, the complete location profile comprising a set of item identifiers, wherein (i) each item identifier included in the set of item identifiers identifies an item that had been consumed using a communication device associated with the complete location profile, (ii) the first communication device and a second communication device that is separate and distinct from the first communication device are both associated with the complete location profile, and (iii) the set of item identifiers includes at least one item identifier that identifies an item that has not been consumed using the first communication device;
instructions for obtaining a first device profile associated with the first communication device, the first device profile comprising static information pertaining to the first communication device and/or dynamic information identifying a set of items consumed using the first communication device;
instructions for determining the set of one or more items to recommend to a user of the first communication device; and
instructions for transmitting, from the recommender system to the first communication device, information identifying the determined set of one or more items, wherein
the instructions for determining the set of one or more items to recommend to the user comprises instructions for using (a) information from the complete location profile and (b) information from the first device profile to select one or more items to include in the set of one or more items to recommend to the user.

15. The recommender computer program product of claim 14, wherein the instructions using said information obtained from the complete location profile and said information obtained from the first device profile comprises:
instructions for determining a set of candidate items using said information obtained from the complete location profile; and
instructions for filtering the set of candidate items using static information obtained from the first device profile.

16. The recommender computer program product of claim 14, further comprising instructions for obtaining a device type profile associated with a communication device type identifier associated with a particular communication device type, wherein
the first communication device is of said particular communication device type, and
the device type profile comprises, for each of a plurality of users, each of whom is a different user than the first user, information identifying items consumed by the user using a communication device, other than the first communication device, of said particular communication device type.

17. The recommender computer program product of claim 16, wherein
the instructions for determining the set of recommended items further comprises:
instructions for obtaining from the device type profile information that identifies an item consumed by one of said plurality of users using a communication device of said particular communication device type other than the first communication device; and
instructions for using (a) said information obtained from the complete location profile, (b) said information obtained from the device type profile, and (c) said information obtained from the first device profile to determine the set of items to recommend to the user.

18. The recommender computer program product of claim 14, further comprising:
instructions for obtaining a user profile associated with a user identifier chosen by the user, wherein the user profile comprises information identifying a set of items consumed by the user, wherein
the instructions for determining the set of recommended items further comprises:
instructions for obtaining from the user profile information that identifies an item consumed by the user; and
instructions for using (a) said information obtained from the complete location profile, (b) said information obtained from the user profile, and (c) said information obtained from the first device profile.
